(19) United States
(12) Patent Application Publication
(10) Pub. No.: US 2018/0228082 A1
(43) Pub. Date: Aug. 16, 2018

(54) Dual reel lawn mower

(71) Applicant: Jacob Isaiah Harrison, Mobile, AL (US)

(72) Inventor: Jacob Isaiah Harrison, Mobile, AL (US)

(73) Assignee: Seed Volage Tech Corporation, Mobile, AL (US)

(21) Appl. No.: 15/432,911

(22) Filed: Feb. 14, 2017

(51) Int. Cl. A01D 34/44; A01D 34/54; A01D 34/53

(52) U.S. Cl. CPC A01D 34/44; A01D 2101/00; A01D 34/53; A01D 34/54

(57) ABSTRACT

A dual reel lawn mower is disclosed. The present invention discloses the line-up of two reel mowers connected by a bar that allows an more efficiently and effectively way to cut the grass on one cut with the dual action of two mowers being used. A dual reel lawn mower comprises two individual reel cutting units, one reel cutting unit is connected by a second reel cutting unit by a connection bar, wherein the first reel cutting unit and the second reel cutting unit are connected front and rear to one another disposed in a moving position. The present invention allows a user the convenience of saving time by cutting twice at one time.

### BACKGROUND OF THE INVENTION

Prior art lawn mowers are of the reel or rotary design. A reel mower is an old-style, which many people still use today. It is better than gas, battery or electric power because it has less maintenance, is less noisy, and has no pollution. More and more people prefer to use a reel mower after they use it. Reel mowers are better for the look of the grass as it has a better cut. Reel mowers can give lawn that nice greenery look, and cut smoother.

Rotary mowers are rougher to the lawn and can tear the grass.

Prior art reel mowers are of one mower that cuts grass, but you usually have to go over the cut a second time to get the best results. The present invention has two reel mowers instead of only using one mower. Therefore, there is a need to develop a faster way to cut that incorporates the dual action of two reel mowers to overcome the problems associated with the prior art of using one reel mower.

### FIELD OF THE INVENTION

The present invention relates to lawn mowers. More particularly, this invention relates to a dual reel lawn mower.

### SUMMARY OF THE INVENTION

In accordance with the present invention there is provided a dual reel lawn mower that has a line-up of two reel mowers connected by a bar in the preferred embodiment that allows an more efficiently and effectively way to cut the grass on one cut with the dual action of two mowers being used.

Two reel cutting units are employed and when pushed forward it will cut the grass with blades of the two mowers and a roller if desired and wheels for movement over the ground allowing a user to cut grass faster.

One reel cutting unit has a blade assembly that can consist of conventional parts eg. reel blades, screws, cutting bar, axle, brush bar, pinion gear, brackets, discs that are spaced between the blades of conventional construction and etc. The blade rotates about on the horizontal axis of the assembly. When a user pushes the present invention, the blades rotate over the lawn, brushing up the grass as it's cut with one blade following the next in quick succession. The dual action of using two reel mowers connected is useful for cutting grass one time without having to go over it twice. It will be understood that there could be as many reel blades or discs as may be desired and of various styles, depending on the width of the mower which is to be made. The handle can be placed on the front, rear, top, sides of the present invention depending on someone skilled in the art's preference. The handle can be made of conventional construction as the preferred embodiments or alternative embodiments can be used such as being flexible to bend in order to have room for storage or of various sizes and shapes. The rollers and/or wheels support the reel mowers thereof in the moving direction and preferred embodiments of the wheels are of the same size. The wheels can have hubcaps of various designs.

The present invention can be made with or without a roller or with or without a leveler wherein the height of the mower can be adjusted by the user if desired.

In a preferred embodiment, the present invention has a roller and a handle foundation lifted up.

It is an object of the present invention to provide a dual reel lawn mower that cuts twice as fast to help a user save time. It is another object of the invention to provide an improved reel lawn mower which can be easily made, used and maintained. In accordance with the objects of the invention a dual reel lawn mower is provided.

### BRIEF DESCRIPTIONS OF THE DRAWINGS

The invention will be better understood and objects other than those set forth above will become apparent when consideration is given to the following detailed description thereof.

Such description makes reference to the drawings wherein:

FIG. 1 is side view of the preferred embodiment of the present invention and showing the handle (1), the handle foundation bracket (2), connection bar (3), tire (4), top cover piece (5), roller (6), and blade assembly (7) in an fragmentary elevational view. The roller is made as a two-piece.

FIG. 2 is a reduced view of an alternative embodiment without a roller (6) showing the bottom bar (9) and handle (1) in a different position and with levelers (8) for each tire (4) to adjust the height of the present invention also showing the top cover piece (5) and blade assembly (7).

FIG. 3 is a fragmentary view according to embodiments of this invention showing the top cover piece (5) that can be used.

FIG. 4 is a perspective view of an alternative embodiment of the present invention showing a handle in a different position, a shorter roller and a different reel blade being used.

### DETAILED DESCRIPTIONS OF THE DRAWINGS

In the following exemplary description numerous specific details are set forth in order to provide a more thorough understanding of embodiments of the invention. It will be apparent, however, to an artisan of ordinary skill that the present invention may be practiced without incorporating all aspects of the specific details described herein.

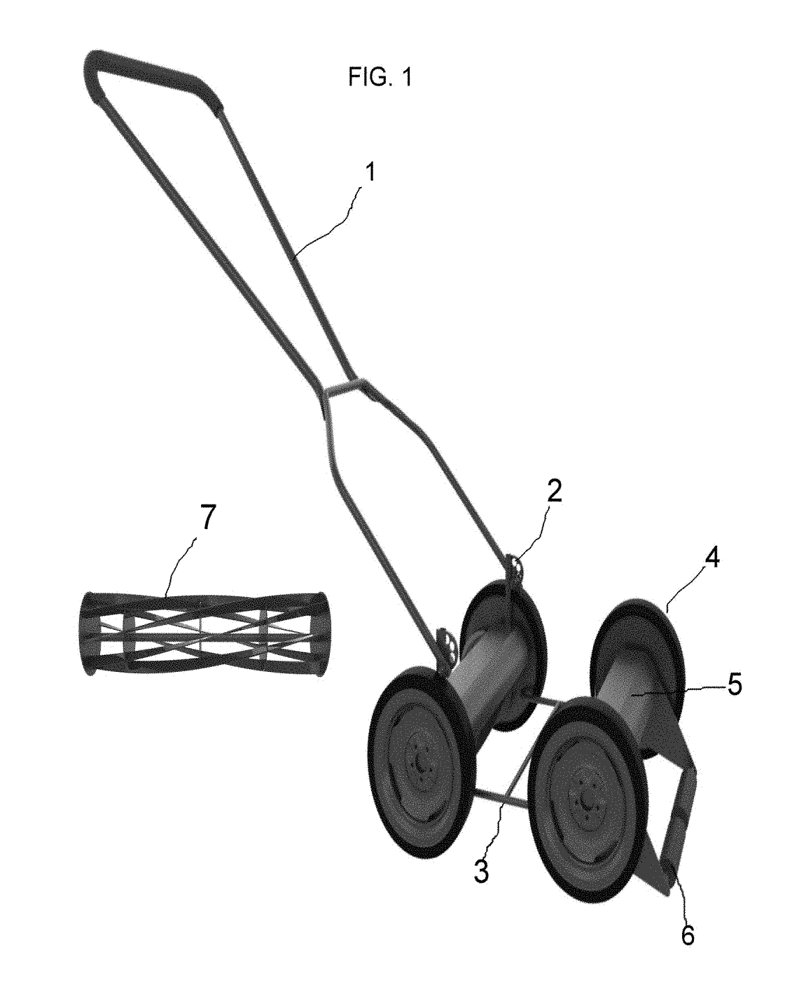

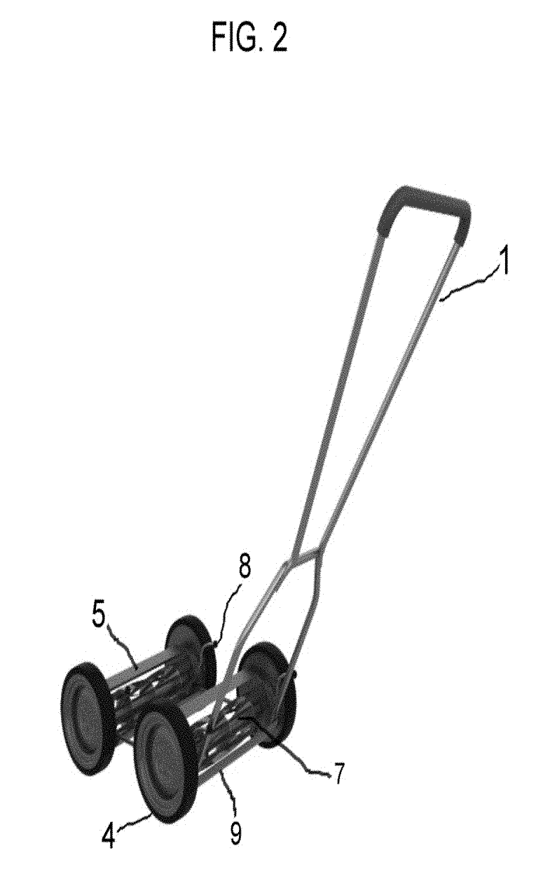

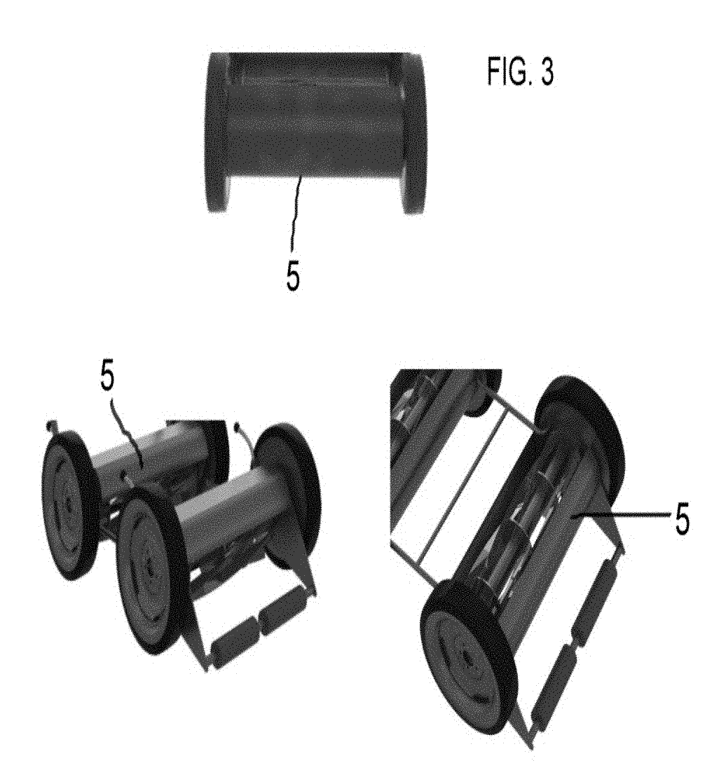

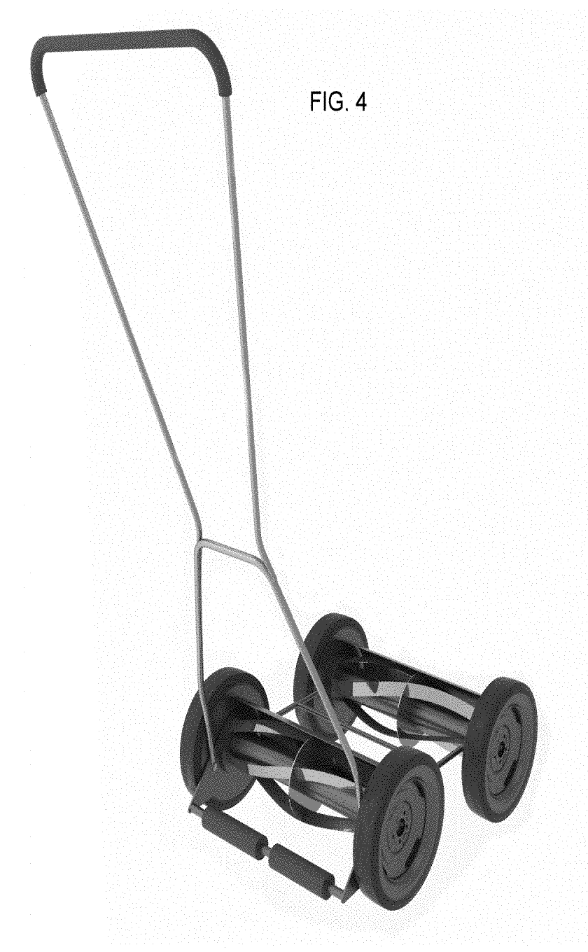

Referring now to the drawings of the present invention, in FIG. 1, shows a dual reel lawn mower in a preferred embodiment. FIG. 1 is showing the side view of the present invention and showing the handle (1) lifted up high in order to move the handle with more flexibility for the user. It also shows the handle foundation bracket (2), connection bar (3), tire (4), top cover piece (5), roller (6), and blade assembly (7) in an fragmentary elevational view. The roller is made as a two-piece; FIG. 2 is a reduced view of an alternative embodiment without a roller (6) showing the bottom bar (9) and handle (1) in a different position and with levelers (8) for each tire (4) to adjust the height of the present invention also showing the top cover piece (5) and blade assembly (7); FIG. 3 is a fragmentary view according to embodiments of this invention showing the top cover piece (5) that can be used and showing how the present invention can be made in alternative ways depending on someone skilled in the art's preference. FIG. 4 is a perspective view of an alternative embodiment of the present invention showing a handle in a different position, a shorter roller and a different reel blade being used.

Therefore, the foregoing is considered as illustrative only of the principles of the invention and the substitution of alternative embodiments are permitted. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. Dual reel lawn mower comprising:
a handle, wheels, two individual reel cutting units, one reel cutting unit is connected by a second reel cutting unit by a connection bar, wherein the first reel cutting unit and the second reel cutting unit are connected front and rear to one another disposed in a moving position to allow a user increased cutting by connection of two reel mowers;

2. Two reel mowers are of conventional construction, that can be made of various sizes and shapes, and connected front to rear generally comprising a frame, connection bar, blade assembly, wheels, with or without a roller to support the reel mowers thereof in the moving direction; With or without a leveler wherein the height of the mower can be adjusted by the user. Two individual reel mowers connected by a bar that enables the first reel cutting unit to connect to the second reel cutting unit thereto. The reel mowers are positioned front and rear to one another and disposed in a forward moving position to allow a user to manually push over the same area allowing increased cutting by connection of two reel mowers.

3. The connection bar of claim 1, wherein said bar is assembled with a respective gap between said front and rear reel cutting units and can be made of conventional construction by a person skilled in the trade that can be made of various sizes and shapes or materials such as: chain, metal piece, wire, or any other suitable material.

4. The wheels of claim 1, wherein said wheels can be made of conventional construction of various sizes and shapes depending on a person skilled in the art's preference.

5. The reel cutting unit of claim 1, wherein said reel cutting unit has a blade assembly that can consist of conventional parts.

6. The handle of claim 1, wherein said handle can be made of conventional construction of various sizes and shapes.

7. The roller of claim 2, wherein said roller can be used if desired and alternative embodiments can be made such as one-piece or multiple pieces as to not limit the claim.

8. The reel blades of claim 5, wherein said reel blades is included in the blade assembly. The reel blades rotates about on the horizontal axis of the assembly. The reel blades rotate over the lawn, brushing up the grass as it's cut with one blade following the next in quick succession. Embodiments of the blades can be different shapes and sizes, for example can have five or seven blades depending on a person skilled in the art's preference.

9. The leveler of claim 2, wherein said leveler can be used if desired for the height adjusting of the mower depending on how high or low a user wants the grass cut. The leveler is used for raising and lowering the mower.
